(19) United States
(12) Patent Application Publication
(10) Pub. No.: US 2023/0318640 A1
(43) Pub. Date: Oct. 5, 2023

(54) WIRELESS COMMUNICATION APPARATUS AND DISTORTION COMPENSATION METHOD

(71) Applicant: Fujitsu Limited, Kawasaki-shi (JP)

(72) Inventor: Toshihiro SHIMURA, Yokohama (JP)

(73) Assignee: Fujitsu Limited, Kawasaki-shi (JP)

(21) Appl. No.: 18/067,864

(22) Filed: Dec. 19, 2022

(30) Foreign Application Priority Data
Apr. 1, 2022 (JP) 2022-061971

(51) Int. Cl. H04B 1/04

(52) U.S. Cl. CPC H04B 1/0475; H04B 2001/0408

(57) ABSTRACT

A wireless communication apparatus includes a processor configured to output a plurality of transmission signals transmitted by different beams, respectively, a plurality of phase shifters configured to be provided in association with antenna elements and apply phase rotations for forming the beams to the plurality of transmission signals, respectively, a power amplifier configured to amplify a signal that is obtained by combining the transmission signals that are output from the plurality of respective phase shifters, and a feedback path configured to feed back a pre-amplified signal that has not been amplified by the power amplifier and an amplified signal that has been amplified by the power amplifier. The processor executes a process including calculating a distortion compensation coefficient based on a difference between the pre-amplified signal and the amplified signal, and performing distortion compensation on the plurality of transmission signals by using the calculated distortion compensation coefficient.

### CROSS-REFERENCE TO RELATED APPLICATION

This application is based upon and claims the benefit of priority of the prior Japanese Patent Application No. 2022-061971, filed on Apr. 1, 2022, the entire contents of which are incorporated herein by reference.

### FIELD

The embodiments discussed herein are related to a wireless communication apparatus and a distortion compensation method.

### BACKGROUND

In recent years, for example, in an ultra-high frequency band, such as a microwave band and a millimeter waveband, beamforming has been practically used as one of the technologies for implementing multiplex communication or high accuracy of sensing (radar). A beamforming device that implements beamforming includes a plurality of antenna elements that are arranged in an array.

Furthermore, developments of a system (beam multiplexing system) of superimposing a plurality of different signals and forming a plurality of beams each facing a different direction has been facilitated. As one of methods for implementing beam multiplexing, studies are being conducted on a technology for distributing output signals received from a plurality of digital analog converters (DACs) that perform D/A (Digital/Analog) conversion on different signals to a plurality of antenna elements, respectively, combining the signals by adding phase rotations for beamforming to the output signals that have been distributed to the antenna elements, respectively, and transmitting the obtained combined signal from each of the antenna elements.

In contrast, in the beamforming device, in some cases, digital pre-distortion (DPD) for compensating nonlinear distortion that is generated at the time of amplification of a signal performed in a power amplifier is used. DPD is a technology for compensating nonlinear distortion by adding, in advance, distortion having an inverse characteristic of the nonlinear distortion that is generated in the power amplifier to a transmission signal.
Patent Document 1: Japanese Laid-open Patent Publication No. 2021-16077
Patent Document 2: Japanese Laid-open Patent Publication No. 2020-107934
Patent Document 3: International Publication Pamphlet No. WO 2018/199233
Patent Document 4: International Publication Pamphlet No. WO 2018/109862

### SUMMARY

According to an aspect of an embodiment, a wireless communication apparatus includes a processor configured to output a plurality of transmission signals that are transmitted by different beams, respectively, a plurality of phase shifters configured to be provided in association with antenna elements and apply phase rotations for forming the beams to the plurality of transmission signals, respectively, a power amplifier configured to amplify a signal that is obtained by combining the transmission signals output from the plurality of respective phase shifters, and a feedback path configured to feed back a pre-amplified signal that has not been amplified by the power amplifier and an amplified signal that has been amplified by the power amplifier. The processor executes a process includes calculating a distortion compensation coefficient based on a difference between the pre-amplified signal and the amplified signal, and performing distortion compensation on the plurality of transmission signals by using the calculated distortion compensation coefficient.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a communication system according to a first embodiment;

FIG. 2 is a block diagram illustrating a configuration of a RU according to the first embodiment;

FIG. 3 is a block diagram illustrating a configuration of a main part of the RU according to the first embodiment;

FIG. 4 is a flowchart illustrating a method for calculating a coefficient according to the first embodiment;

FIG. 5 is a flowchart illustrating a distortion compensation coefficient calculation process according to the first embodiment;

FIG. 6 is a block diagram illustrating a configuration of a main part of a RU according to a second embodiment;

FIG. 7 is a flowchart illustrating a method for calculating a coefficient according to the second embodiment;

FIG. 8 is a flowchart illustrating a distortion compensation coefficient calculation process according to the second embodiment;

FIG. 9 is a block diagram illustrating a configuration of a main part of a RU according to another embodiment; and

FIG. 10 is a block diagram illustrating a configuration of a main part of a RU according to still another embodiment.

### DESCRIPTION OF EMBODIMENTS

However, in a case in which beam multiplexing is performed, there is a problem in that it is difficult to compensate the nonlinear distortion generated in the power amplifier that is provided in association with each of the antenna elements. Specifically, in a case in which beam multiplexing is performed, output signals that have been output from a plurality of DACs are distributed to the respective antenna elements, and different phase rotations are applied to the plurality of respective output signals that are distributed to a single antenna element. Then, combined signals that are obtained by combining the signals to which different phase rotations are applied are input to the power amplifiers that are provided in association with the antenna elements, respectively, so that each of the power amplifiers accordingly amplifies a combined signal in which a plurality of signals each having a different phase are present in a mixed manner. Accordingly, it is difficult to accurately estimate nonlinear distortion generated in the power amplifier even if the output signal that has been output from the power amplifier is fed back, and thus, a distortion compensation coefficient is not correctly updated. As a result, it is difficult to perform distortion compensation that is performed by applying the distortion compensation coefficient to the transmission signal.

Preferred embodiments will be explained with reference to accompanying drawings. The present invention is not limited to the embodiments.

### [a] First Embodiment

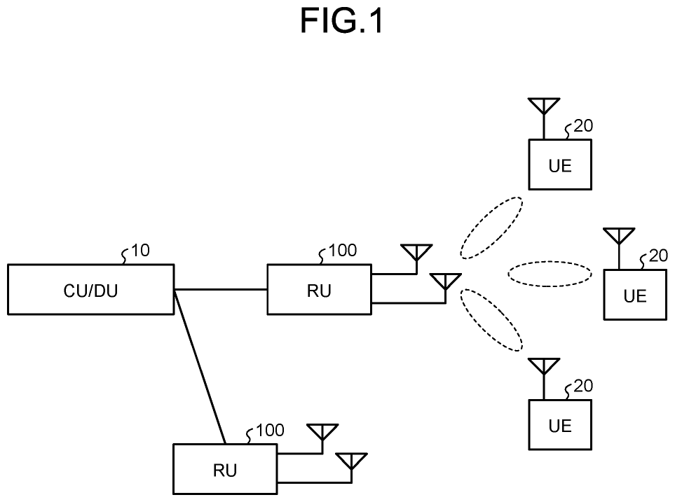

FIG. 1 is a diagram illustrating an example, of a communication system according to a first embodiment. In the communication system illustrated in FIG. 1, a plurality of radio units (RUs) 100 are connected to a central unit/distributed unit (CU/DU) 10, and the RUs 100 and user equipments (UEs) 20 perform wireless communication. Furthermore, the CU/DU 10 need not always be configuration as an integrated device, and may be configured such that a CU and a DU are configured as separated devices.

The CU/DU 10 is a device that performs baseband process on a signal, generates a transmission baseband signal by encoding, for example, information, transmits the generated transmission baseband signal to the RU 100, and decodes the reception baseband signal received from the RU 100. The CU/DU 10 transmits, to the RUs 100, a plurality of transmission baseband signals addressed to the plurality of respective UEs 20.

Each of the RUs 100 is connected to the CU/DU 10 in a wired manner, performs a wireless transmission process on the transmission baseband signal that has been generated by the CU/DU 10, generates a reception baseband signal by performing a wireless reception process on a reception signal received from the UE 20, and transmits the generated reception baseband signal to the CU/DU 10. Furthermore, each of the RUs 100 is a wireless communication apparatus that includes a plurality of antenna elements and that performs beamforming by adding an antenna weight to each of the plurality of antenna elements at the time of wireless communication performed with the UE 20. At this time, each of the RUs 100 multiplexes a plurality of beams that are associated with the plurality of respective UEs 20, and simultaneously transmits signals addressed to the plurality of UEs 20 by using the beams, respectively.

Furthermore, each of the RUs 100 performs digital pre-distortion that compensates nonlinear distortion generated in a power amplifier that is provided in each of the antenna elements. In the digital pre-distortion, a distortion compensation coefficient is multiplied by the transmission signal, and the distortion compensation coefficient is calculated on the basis of a difference between a signal that has not been amplified by the power amplifier and a signal that has been amplified by the power amplifier. A configuration and an operation of the RUs 100 will be described in detail later.

The UEs 20 are user terminal devices, such as mobile telephones or smartphones, and perform wireless communication with the RUs 100.

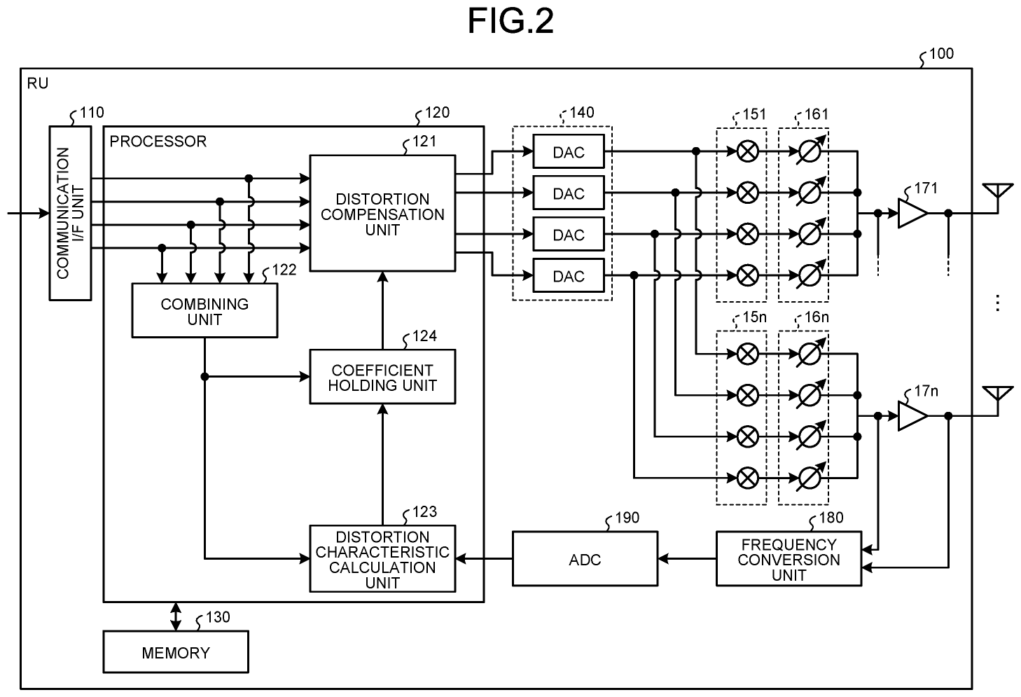

FIG. 2 is a block diagram illustrating a configuration of the RU 100 according to the first embodiment. The RU 100 illustrated in FIG. 2 is a wireless communication apparatus that includes n antenna elements (n is an integer greater than or equal to 2). The RU 100 includes a communication interface unit (hereinafter, simply referred to as a “communication I/F unit”) 110, a processor 120, a memory 130, a digital analog converter (DAC) 140, up-converters 151 to 15n, phase shifters 161 to 16n, power amplifiers 171 to 17n, a frequency conversion unit 180, and a analog digital converter (ADC) 190. Furthermore, FIG. 2 illustrates processing units associated with a process for transmitting a signal to the UE 20, and processing units associated with a process for receiving a signal from the UE 20 are not illustrated.

The communication I/F unit 110 is an interface that is connected to the CU/DU 10 in a wired manner, and that transmits and receives a baseband signal to and from the CU/DU 10. Specifically, the communication I/F unit 110 receives the transmission baseband signal that has been transmitted from the CU/DU 10, and transmits a reception baseband signal to the CU/DU 10. The communication I/F unit 110 receives the transmission baseband signals addressed to the plurality of respective UEs 20, and outputs the transmission baseband signals addressed to the respective UEs 20 to the processor 120. In FIG. 2, it is assumed that the communication I/F unit 110 outputs four transmission baseband signals that are addressed to the respective four UEs 20. The four UEs 20 are located in different directions and are associated with multiplexed beams. In other words, the communication I/F unit 110 outputs the number of transmission baseband signals corresponding to the number of multiplexed beams to the processor 120.

The processor 120 includes, for example, a Central Processing Unit (CPU), a Field Programmable Gate Array (FPGA), a Digital Signal Processor (DSP), or the like, and performs overall control of each of the RUs 100. Specifically, The processor 120 includes a distortion compensation unit 121, a combining unit 122, a distortion characteristic calculation unit 123, and a coefficient holding unit 124.

The distortion compensation unit 121 performs distortion compensation on a transmission signal by multiplying a distortion compensation coefficient that is output from the coefficient holding unit 124 by each of the transmission baseband signals associated with the plurality of respective beams. The distortion compensation unit 121 outputs, to the DAC 140, the transmission signals that are associated with the respective beams and in each of which the distortion compensation coefficient has been multiplied.

The combining unit 122 combines the transmission baseband signals associated with the plurality of respective beams, and outputs the obtained combined signal to the distortion characteristic calculation unit 123 and the coefficient holding unit 124. At this time, the combining unit 122 applies, to the transmission baseband signals associated with the respective beams, a weight associated with the phase rotation that is to be added by each of the phase shifters 161 to 16n, and combines the transmission baseband signals that have been subjected to the weighting. Then, the combining unit 122 outputs weighting information on the weighting of the transmission baseband signals together with the combined signal to the distortion characteristic calculation unit 123 and the coefficient holding unit 124.

The distortion characteristic calculation unit 123 calculates a distortion characteristic of each of the power amplifiers 171 to 17n on the basis of a difference between a pre-amplified signal that is obtained before the signal is input to each of the power amplifiers 171 to 17n and an amplified signal that is output from each of the power amplifiers 171 to 17n. In other words, the distortion characteristic calculation unit 123 acquires, from the ADC 190, a feedback signal that is obtained by cancelling the phase rotations applied by each of the phase shifters 161 to 16n as a result of obtaining a difference between the pre-amplified signal and the amplified signal, and then, calculates a distortion characteristic of each of the power amplifiers 171 to 17n from the acquired feedback signal.

Then, the distortion characteristic calculation unit 123 accumulates the calculated distortion characteristics by associating each of the distortion characteristics with the combined signal and the weighting information in a predetermined period of time for the initial setting. After elapse of the predetermined period of time for the initial setting, the distortion characteristic calculation unit 123 calculates an inverse characteristic of the distortion characteristic that is associated with the combined signal and the weighting information, and outputs the distortion compensation coefficient associated with the inverse characteristic to the coefficient holding unit 124. In addition, after elapse of the predetermined period of time for the initial setting, the distortion characteristic calculation unit 123 updates the distortion compensation coefficient by using the accumulated distortion characteristics and the feedback signal received from the ADC 190.

The coefficient holding unit 124 holds the distortion compensation coefficient that has been output from the distortion characteristic calculation unit 123 by associating the distortion compensation coefficient with the combined signal and the weighting information. Then, the coefficient holding unit 124 calculates a distortion compensation coefficient that is associated with the transmission baseband signal for each beam by multiplying a distribution coefficient by the distortion compensation coefficient that is associated with both of the combined signal and the weighting information, and outputs the calculated distortion compensation coefficient for each beam to the distortion compensation unit 121.

The memory 130 includes, for example, a random access memory (RAM), a read only memory (ROM), or the like, and stores various kinds of information when a process is performed by the processor 120.

The DAC 140 is provided in association with the beams and performs D/A conversion on each of the transmission signals that have been subjected to distortion compensation by the processor 120. In other words, in FIG. 2, the four DACs 140 associated with the respective four beams to be multiplexed perform D/A conversion on the transmission signals that are associated with the respective beams. The transmission signals that have been subjected to D/A conversion by the DACs 140 are distributed to n antenna elements, respectively.

The up-converters 151 to 15n are provided in n antenna elements in association with the beams, respectively. Then, each of the up-converters 151 to 15n performs up-conversion on the transmission signal for each beam, and converts the signal to a transmission signal at a radio frequency bandwidth.

The phase shifters 161 to 16n are provided in n antenna elements in association with beams, respectively. Then, each of the phase shifters 161 to 16n applies a phase rotation for forming a beam to the transmission signal for each beam. At this time, each of the phase shifters 161 to 16n applies a different phase rotation in accordance with the beam to a plurality of transmission signals (in this case, four transmission signals) that are transmitted from the same antenna element. The plurality of transmission signals in which the phase rotations have been applied by the respective phase shifters 161 to 16n are combined and input to the power amplifiers 171 to 17n that are associated with the phase shifters 161 to 16n, respectively.

The power amplifiers 171 to 17n amplify the input signals and wirelessly transmit the amplified signals from the respective antenna elements. The signals that are input to the respective power amplifiers 171 to 17n are signals that are obtained by combining the plurality of transmission signals and in which different phase rotations have been applied. In addition, when each of the power amplifiers 171 to 17n amplifies a signal, nonlinear distortion is generated. The nonlinear distortion is compensated by distortion compensation performed by the distortion compensation unit 121.

The frequency conversion unit 180 provides feedback on the pre-amplified signal that has not been amplified by the power amplifiers 171 to 17n and the amplified signal that has been amplified by the power amplifiers 171 to 17n, and performs down-conversion on these signals and converts these signals to signals at the intermediate frequency or the baseband frequency. At this time, the frequency conversion unit 180 inverts the phases of local signals that are used for down-conversion to be performed on the pre-amplified signal and the amplified signal, and allows the phases of the pre-amplified signal and the amplified signal to have opposite phases. Then, by adding the pre-amplified signal and the amplified signal that have been subjected to down-conversion, the frequency conversion unit 180 obtains a difference between before and after amplification performed by the power amplifiers 171 to 17n, and outputs the feedback signal that indicates the difference to the ADC 190. By obtaining the difference between the pre-amplified signal and the amplified signal, the phase rotations that have been applied to the transmission signals by the phase shifters 161 to 16n, respectively, are canceled out, so that the feedback signal corresponds to a distortion component generated in the power amplifiers 171 to 17n.

The ADC 190 performs A/D conversion on the feedback signal that is output from the frequency conversion unit 180. Then, the ADC 190 outputs the feedback signal that has been converted to the digital signal to the distortion characteristic calculation unit 123.

Each of the frequency conversion unit 180 and the ADC 190 constitutes a feedback path for providing feedback on the pre-amplified signal and the amplified signal in a power amplifier 170 to the processor 120.

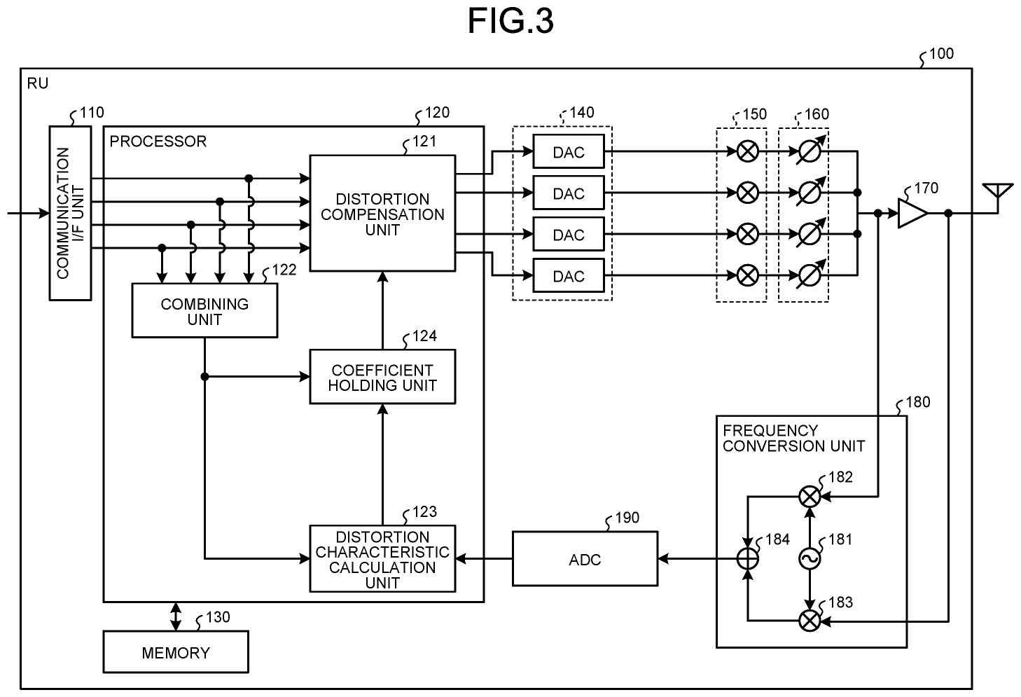

In the following, a feedback signal that is fed back to the processor 120 will be more specifically described with reference to FIG. 3. FIG. 3 is a block diagram illustrating a configuration of a main part of the RU 100 according to the first embodiment. FIG. 3 illustrates an up-converter 150, a phase shifter 160, and the power amplifier 170 that are associated with a single antenna element. The up-converter 150, the phase shifter 160, and the power amplifier 170 represent the up-converters 151 to 15n, the phase shifters 161 to 16n, and the power amplifiers 171 to 17n, respectively, illustrated in FIG. 2.

As illustrated in FIG. 3, the frequency conversion unit 180 includes a local oscillator 181, down-converters 182 and 183, and an adder 184. The pre-amplified signal in the power amplifier 170 is into the down-converter 182, and the amplified signal in the power amplifier 170 is input to the down-converter 183.

The local oscillator 181 generates a local signal that is used for down-conversion to be performed on the pre-amplified signal and the amplified signal. Specifically, the local oscillator 181 generates local signals that have the same frequency as that of the pre-amplified signal and the amplified signal and that have inverse phases with respect to the pre-amplified signal and the amplified signal, respectively. Then, the local oscillator 181 supplies the local signal having the inverse phase to each of the down-converters 182 and 183.

The down-converter 182 performs down-conversion on the pre-amplified signal by using the local signal that is supplied from the local oscillator 181.

The down-converter 183 performs down-conversion on the amplified signal by using the local signal that is supplied from the local oscillator 181.

The adder 184 adds the pre-amplified signal that has been subjected to down-conversion by the down-converter 182 to the amplified signal that has been subjected to down-conversion by the down-converter 183, and obtains a difference before and after the amplification performed by the power amplifier 170. In other words, because the pre-amplified signal and the amplified signal are subjected to down-conversion by the local signals having inverse phases and have opposite phases with each other, the adder 184 adds the pre-amplified signal and the amplified signal and cancels out the phases by obtaining a difference between both of the signals. In the feedback signal obtained in this way, different phase rotations applied, by the phase shifter 160, to the respective transmission signals that are associated with the respective beams have been canceled out. Therefore, the feedback signal is a signal in which the effect of the phase rotation applied by the phase shifter 160 has been removed, and functions as a signal that indicates nonlinear distortion generated in the power amplifier 170.

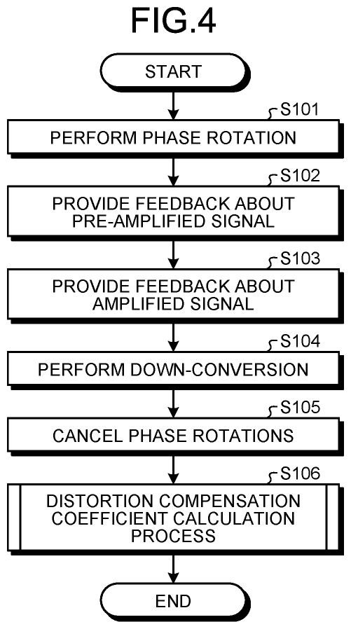

In the following, a method for calculating a distortion compensation coefficient in the RU 100 having the configuration described above will be described with reference to the flowchart illustrated in FIG. 4.

The transmission signals that are associated with the respective beams and that are output from the processor 120 are subjected to D/A conversion by the respective DACs 140, and are subjected to up-conversion by the respective up-converters 150. Phase rotations are applied, by the respective phase shifters 160, to the transmission signals that are associated with the respective beams and that have been subjected to up-conversion and become signals with the radio frequency (Step S101). In other words, different phase rotations are applied to the plurality of respective transmission signals that are present in the respective antenna elements in accordance with the respective beam directions. Then, the transmission signals that are associated with the respective beams and in which the phase rotations have been applied are combined and input to the power amplifier 170. Accordingly, a signal in which transmission signals each having a different phase are present in a mixed manner is input to the power amplifier 170.

The pre-amplified signal that has not been input to the power amplifier 170 is fed back to the down-converter 182 included in the frequency conversion unit 180 (Step S102). In addition, the amplified signal that has been amplified by the power amplifier 170 and that is output from the power amplifier 170 is wirelessly transmitted from the antenna element and is fed back to the down-converter 183 included in the frequency conversion unit 180 (Step S103).

The fed back pre-amplified signal and the fed back amplified signal are subjected to down-conversion by each of the down-converters 182 and 183 (Step S104). At this time, the local signals supplied from the local oscillator 181 to the down-converters 182 and 183 have the same frequency and the inverse phases, so that the pre-amplified signal and the amplified signal that have been subjected to down-conversion are the signals with opposite phases.

The pre-amplified signal and the amplified signal with opposite phases are added by the adder 184, so that the phase rotations applied to the transmission signals that are associated with the respective beams by the phase shifter 160 are canceled out (Step S105). In other words, as a result of the signals each having an opposite phase being added, a difference between the pre-amplified signal and the amplified signal is obtained, and the phase rotation components that are included in the pre-amplified signal and the amplified signal are canceled out. As a result, the distortion component that is associated with the nonlinear distortion generated in the power amplifier 170 is output from the adder 184. The distortion component is subjected to A/D conversion by the ADC 190 and is output to the processor 120.

Then, in the processor 120, a distortion characteristic of the power amplifier 170 is calculated from the distortion component, and a process of calculating a distortion compensation coefficient for compensating the distortion characteristic is calculated (Step S106). In this way, because the distortion compensation coefficient is calculated by using the difference between the pre-amplified signal and the amplified signal, even if different phase rotations have been applied to the transmission signals that are associated with the beams, respectively, by the phase shifter 160, it is possible to appropriately calculate a distortion characteristic of the power amplifier 170 by canceling out the phase rotation components. As a result, it is possible to implement the distortion compensation of the power amplifier 170 in which the signal that is obtained by combining the transmission signals associated with the respective beams is input.

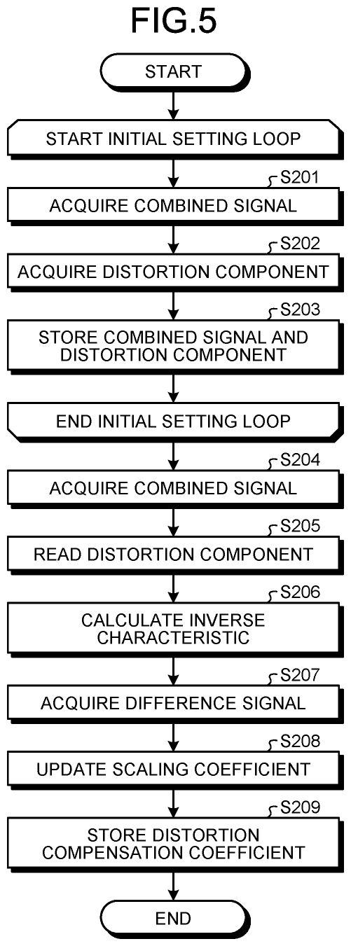

In the following, a distortion compensation coefficient calculation process will be specifically described with reference to the flowchart illustrated in FIG. 5.

A process for initial setting is repeatedly performed in a predetermined period of time at the time of, for example, a start-up of the RU 100 or the like. Specifically, when the transmission signals associated with the respective beams are input to the processor 120, these transmission signals are combined by the combining unit 122 by being subjected to weighting that is associated with the phase rotation performed by the phase shifter 160, and a combined signal is acquired (Step S201). In addition, at the time of initial setting, the transmission signals associated with the respective beams are output to the DAC 140 in a state in which the distortion compensation coefficient is not set in the distortion compensation unit 121 and the distortion compensation coefficient is not multiplied. Then, the transmission signals associated with the respective beams are subjected to D/A conversion and are then subjected to up-conversion to the signals with the radio frequency, and the phase rotations for beamforming are applied. These transmission signals are combined and input to the power amplifier 170 and are subjected to wireless transmission from the respective antenna elements, and the pre-amplified signal and the amplified signal are fed back to the frequency conversion unit 180.

Then, in the frequency conversion unit 180, a difference between the pre-amplified signal and the amplified signal is obtained by performing down-conversion using the local signals each having an inverse phase. Here, the distortion compensation coefficient is not multiplied by the transmission signals that are associated with the respective beams, so that the distortion component in the power amplifier 170 is acquired by obtaining the difference between the pre-amplified signal and the amplified signal (Step S202). In other words, by obtaining the difference between the pre-amplified signal and the amplified signal, the signal components including the phase rotations that are applied by the phase shifter 160 are canceled out, the distortion component generated in the power amplifier 170 is output from the frequency conversion unit 180.

The distortion component is input to the distortion characteristic calculation unit 123, and the combined signal acquired by the combining unit 122 and the distortion component are stored in an associated manner (Step S203). At this time, weighting information at the time at which the transmission signals associated with the respective beams are combined may be simultaneously stored.

In this way, a process of accumulating the distortion component in the power amplifier 170 in association with the combined signal and the weighting information is repeatedly performed in predetermined period of time for the initial setting. As a result, the nonlinear distortion generated in the power amplifier 170 is stored at each level of the combined signal.

Then, if the predetermined period of time for the initial setting has elapsed, the transmission signals that are associated with the respective beams and that are input to the processor 120 are combined, by the combining unit 122, after being subjected to weighting that is associated with the phase rotation performed by the phase shifter 160, and then, the combined signal is acquired (Step S204). Then, the distortion component that is stored in association with the combined signal is read by the distortion characteristic calculation unit 123 (Step S205), and the inverse characteristic of this distortion component is calculated (Step S206). The calculated inverse characteristic is multiplied by a scaling coefficient with the initial value of, for example, 1, and the multiplication result is stored as the distortion compensation coefficient in the coefficient holding unit 124. A distortion compensation coefficient for each beam is calculated by multiplying the distortion compensation coefficient by the distribution coefficient that is associated with the weighting information on the combined signal, and then, the distortion compensation on the transmission signals associated with the respective beams is performed by the distortion compensation unit 121.

In also the case where the distortion compensation has been performed, a difference signal between the pre-amplified signal and the amplified signal is acquired by the frequency conversion unit 180 (Step S207), and the difference signal is fed back to the distortion characteristic calculation unit 123. Then, the scaling coefficient or the distribution coefficient is updated by using, for example, the LMS algorithm such that an error between the inverse characteristic calculated at Step S206 and the difference signal is the minimum by the distortion characteristic calculation unit 123 (Step S208). When the scaling coefficient has been updated, the updated scaling coefficient is multiplied by the inverse characteristic, and the obtained distortion compensation coefficient is stored in the coefficient holding unit 124 (Step S209). In addition, if the distribution coefficient has been updated, the updated distribution coefficient is multiplied by the distortion compensation coefficient that is stored in the coefficient holding unit 124, whereby the distortion compensation coefficient for each beam has been calculated.

In this way, by calculating the distortion compensation coefficient by using the difference between the pre-amplified signal and the amplified signal, it is possible to calculate the distortion compensation coefficient related to the power amplifier 170 that amplifies the signal that is obtained by combining the transmission signals that are associated with the respective beams and in each of which a different phase rotation has been applied.

As described above, according to the present embodiment, in the case where a power amplifier amplifies the signal that is obtained by combining the transmission signals that are associated with the respective beams and in each of which a different phase rotation is applied, a difference between the pre-amplified signal and the amplified signal is obtained, and a distortion compensation coefficient is calculated by using the difference. Accordingly, it is possible to calculate a distortion compensation coefficient that is associated with the nonlinear distortion generated in the power amplifier by canceling out the phase rotations applied to the transmission signals that are associated with the respective beams. As a result, it is possible to perform distortion compensation with high accuracy even when beam multiplexing is performed.

### [b] Second Embodiment

The characteristic of a second embodiment is that a difference is obtained after a pre-amplified signal and an amplified signal have been converted to a digital signal.

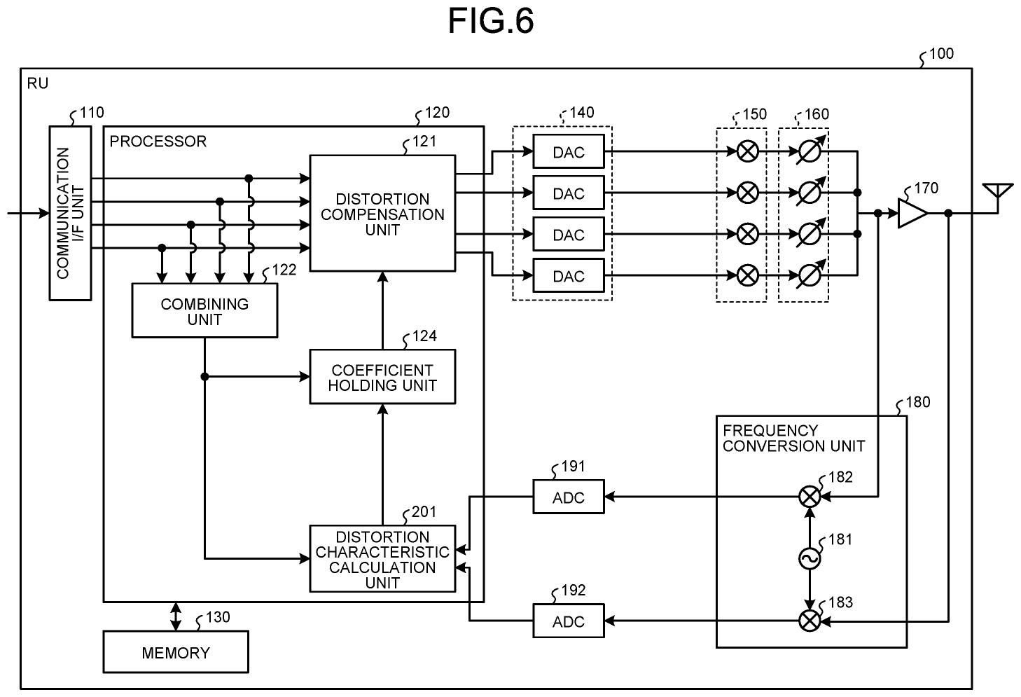

A configuration of a communication system according to the second embodiment is the same as that described in the first embodiment (FIG. 1); therefore, descriptions thereof will be omitted. FIG. 6 is a block diagram illustrating a configuration of a main part of the RU 100 according to the second embodiment. In FIG. 6, components that are the same as those illustrated in FIG. 3 are assigned the same reference numerals and descriptions thereof will be omitted. The RU 100 illustrated in FIG. 6 includes a distortion characteristic calculation unit 201 and ADCs 191 and 192 instead of the distortion characteristic calculation unit 123 and the ADC 190, respectively, illustrated in FIG. 3.

Furthermore, in the second embodiment, the frequency conversion unit 180 includes the local oscillator 181 and the down-converters 182 and 183. In the second embodiment, the local oscillator 181 may supply local signals with the same frequency and the same phase to the down-converters 182 and 183.

The ADC 191 performs A/D conversion on the pre-amplified signal that has been subjected to down-conversion by the down-converter 182. Then, the ADC 191 outputs the pre-amplified signal that has been converted to a digital signal to the distortion characteristic calculation unit 201.

The ADC 192 performs A/D conversion on the amplified signal that has been subjected to down-conversion by the down-converter 183. Then, the ADC 192 outputs the amplified signal that has been converted to a digital signal to the distortion characteristic calculation unit 201.

The distortion characteristic calculation unit 201 calculates a difference between the pre-amplified signal and the amplified signal, and calculates a distortion characteristic of the power amplifier 170 on the basis of the difference. In other words, the distortion characteristic calculation unit 201 cancels out the phase rotations applied by the phase shifter 160 by obtaining the difference between the pre-amplified signal and the amplified signal, and calculates the distortion characteristic of the power amplifier 170.

Then, the distortion characteristic calculation unit 201 accumulates the calculated distortion characteristics by associating the distortion characteristics with the combined signal and the weighting information in a predetermined period of time for the initial setting. After elapse of the predetermined period of time for the initial setting, the distortion characteristic calculation unit 201 calculates an inverse characteristic of the distortion characteristic associated with the combined signal and the weighting information, and outputs the distortion compensation coefficient associated with the inverse characteristic to the coefficient holding unit 124. Furthermore, after elapse of the predetermined period of time for the initial setting, the distortion characteristic calculation unit 201 updates the distortion compensation coefficient by using the accumulated distortion characteristics and the difference between the pre-amplified signal and the amplified signal.

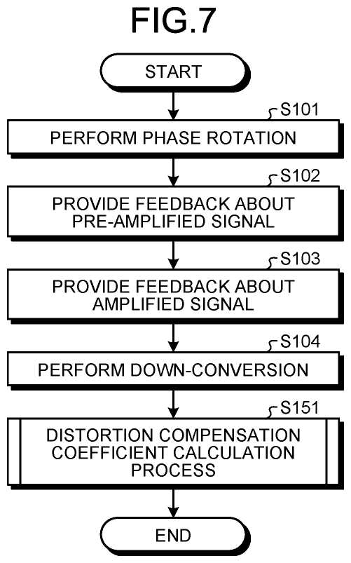

In the following, a method for calculating the distortion compensation coefficient in the RU 100 configured described above will be described with reference to the flowchart illustrated in FIG. 7. In FIG. 7, components that are the same as those illustrated in FIG. 4 are assigned the same reference numerals and descriptions thereof in detail will be omitted.

The transmission signals associated with the respective beams output from the processor 120 are subjected to D/A conversion by the respective DACs 140, and are subjected to up-conversion by the respective up-converters 150. Phase rotations are applied, by the respective phase shifters 160, to the respective transmission signals that are associated with the respective beams and that become signals with a radio frequency after having been subjected to up-conversion (Step S101). Then, the transmission signals that are associated with the respective beams and in each of which a phase rotation has been applied are combined and are input to the power amplifier 170.

The pre-amplified signal that has not been input to the power amplifier 170 is fed back to the down-converter 182 included in the frequency conversion unit 180 (Step S102). In addition, the amplified signal that has been amplified by the power amplifier 170 and that is output from the power amplifier 170 is wirelessly transmitted from the antenna element, and is fed back to the down-converter 183 included in the frequency conversion unit 180 (Step S103).

The pre-amplified signal and the amplified signal that have been fed back are subjected to down-conversion by each of the down-converters 182 and 183 (Step S104). At this time, the local signals supplied from the local oscillator 181 to the down-converters 182 and 183 may have the same frequency and the same phase with each other.

The pre-amplified signal and the amplified signal that have been subjected to down-conversion are subjected to A/D conversion by the respective ADCs 191 and 192 and are output to the processor 120. Then, in the processor 120, a difference between the pre-amplified signal and the amplified signal is obtained, the phase rotation components included in the pre-amplified signal and the amplified signal are canceled out. Accordingly, the difference between the pre-amplified signal and the amplified signal corresponds to the distortion component that is associated with the nonlinear distortion generated in the power amplifier 170. Therefore, in the processor 120, the distortion characteristic of the power amplifier 170 is calculated from the distortion component, and a process of calculating the distortion compensation coefficient that compensates the calculated distortion characteristic is performed (Step S151).

In this way, the distortion compensation coefficient is calculated by using the difference between the pre-amplified signal and the amplified signal, so that, even if different phase rotations are applied to the respective transmission signals that are associated with the respective beams by the phase shifter 160, it is possible to appropriately calculate the distortion characteristic in the power amplifier 170 by canceling out the phase rotation components. As a result, it is possible to implement distortion compensation of the power amplifier 170 that receives an input of the signal that is obtained by combining the transmission signals that are associated with the respective beams.

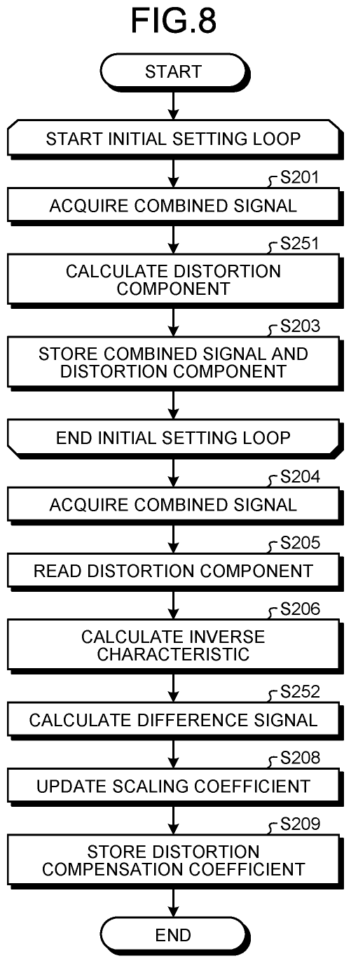

In the following, a distortion compensation coefficient calculation process will be specifically described with reference to the flowchart illustrated in FIG. 8. In FIG. 8, components that are the same as those illustrated in FIG. 5 are assigned the same reference numerals and descriptions thereof in detail will be omitted.

When the transmission signals associated with the respective beams are input to the processor 120, these transmission signals have been subjected to weighting that is associated with the phase rotations applied by the phase shifter 160 and are then combined by the combining unit 122, and then, a combined signal is acquired (Step S201). Furthermore, at the time of initial setting, the transmission signals associated with the respective beams are output to the DAC 140 in a state in which the distortion compensation coefficient is not set in the distortion compensation unit 121 and the distortion compensation coefficient is not multiplied. Then, the transmission signals associated with the respective beams are subjected to D/A conversion and are then subjected to up-conversion to obtain signals with the radio frequency, and then phase rotations for beamforming are applied. These transmission signals are combined and input to the power amplifier 170 and are wirelessly transmitted from the antenna elements, and the pre-amplified signal and the amplified signal are fed back to the frequency conversion unit 180.

Then, the pre-amplified signal and the amplified signal are subjected to down-conversion by the frequency conversion unit 180, are subjected A/D conversion by the respective ADCs 191 and 192, and are input to the distortion characteristic calculation unit 201. In the distortion characteristic calculation unit 201, a difference between the pre-amplified signal and the amplified signal is obtained by digital signal processing. Here, the distortion compensation coefficient is not multiplied by the transmission signals associated with the respective beams, so that the distortion component in the power amplifier 170 is calculated by obtaining the difference between the pre-amplified signal and the amplified signal (Step S251). In other words, by obtaining the difference between the pre-amplified signal and the amplified signal, the signal components including the phase rotations applied by the phase shifter 160 are canceled out, and the distortion component generated in the power amplifier 170 is calculated.

The calculated distortion component is stored in association with the combined signal acquired by the combining unit 122 (Step S203). In this way, a process of accumulating the distortion components in the power amplifier 170 in association with the combined signal is repeatedly performed in a predetermined period of time for the initial setting. As a result, the nonlinear distortion generated in the power amplifier 170 is stored at each of the levels of the combined signals.

Then, after elapse of a predetermined period of time for initial setting, the transmission signals that are associated with the respective beams and that are input to the processor 120 are subjected to weighting that is associated with the phase rotation applied by the phase shifter 160 and are then combined by the combining unit 122, and then a combined signal is acquired (Step S204). Then, the distortion component stored in association with the combined signal is read out by the distortion characteristic calculation unit 201 (Step S205), and an inverse characteristic of the distortion component is calculated (Step S206). The calculated inverse characteristic is used to calculate the distortion compensation coefficient, and distortion compensation of the transmission signals associated with the respective beams is performed by the distortion compensation unit 121.

In also the case in which distortion compensation is performed, a difference signal between the pre-amplified signal and the amplified signal is calculated by the distortion characteristic calculation unit 201 (Step S252), and the scaling coefficient or the distribution coefficient is updated by using, for example, the LMS algorithm such that an error between the inverse characteristic calculated at Step S206 described above and the difference signal is the minimum (Step S208). When the scaling coefficient is updated, the updated scaling coefficient is multiplied by the inverse characteristic, and the obtained distortion compensation coefficient is stored in the coefficient holding unit 124 (Step S209). Furthermore, in the case where the distribution coefficient is updated, the updated distribution coefficient is multiplied by the distortion compensation coefficient that is stored in the coefficient holding unit 124, so that the distortion compensation coefficients associated with the respective beams are calculated.

In this way, by calculating the distortion compensation coefficient by using the difference between the pre-amplified signal and the amplified signal, it is possible to calculate the distortion compensation coefficient related to the power amplifier 170 that amplifies the signal that is obtained by combining the transmission signals that are associated with the respective beams and in each of which a different phase rotation is applied.

As described above, according to the present embodiment, in the case where the power amplifier amplifies the signal that is obtained by combining the transmission signals that are associated with the respective beams and in each of which a different phase rotation is applied, a difference between a pre-amplified signal and an amplified signal is obtained and a distortion compensation coefficient is calculated by using the difference. Accordingly, it is possible to calculate a distortion compensation coefficient associated with the nonlinear distortion generated in the power amplifier by canceling out the phase rotations applied to the respective transmission signals that are associated with the respective beams. As a result, it is possible to implement distortion compensation with high accuracy even in also the case where beam multiplexing is performed.

In addition, in the first and the second embodiments described above, distortion compensation of a single piece of the power amplifier 170 provided in a single antenna element has been described; however, the RU 100 includes a plurality of antenna elements, and the power amplifier 170 is provided in each of the antenna elements. Accordingly, it may be possible to calculate a distortion compensation coefficient that collectively compensate the nonlinear distortion generated in the plurality of power amplifiers 170.

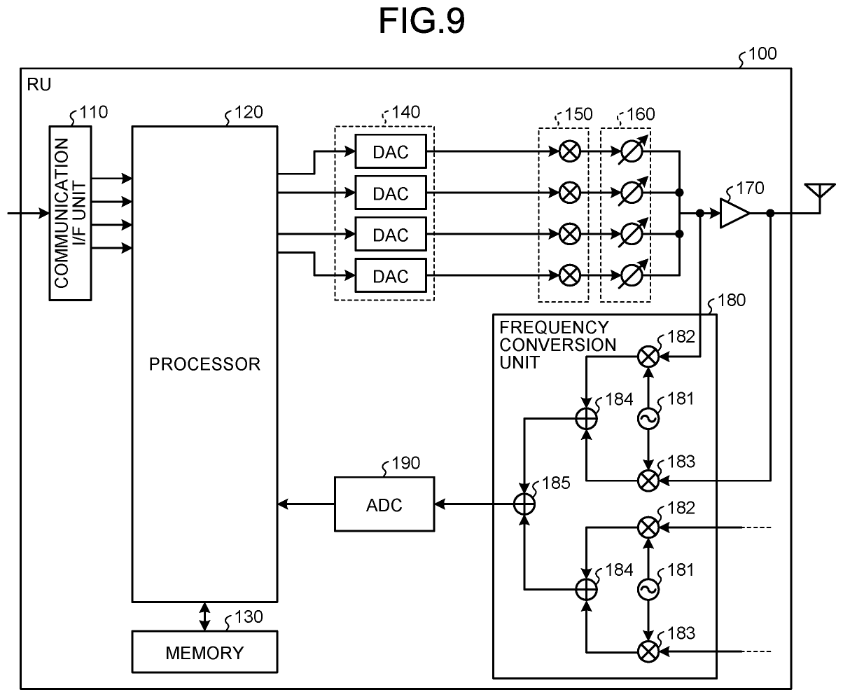

Specifically, for example, as illustrated in FIG. 9, the frequency conversion unit 180 includes the plurality of down-converters 182 and 183 that perform down-conversion on the pre-amplified signal and the amplified signal received from the plurality of antenna elements, respectively, and the plurality of adders 184. Then, it may possible to add a difference between the pre-amplified signal and the amplified signal obtained for each of the antenna elements by an adder 185, and perform a feedback of the signal that is obtained by combining the distortion components of the power amplifiers 170 associated with the respective antenna elements.

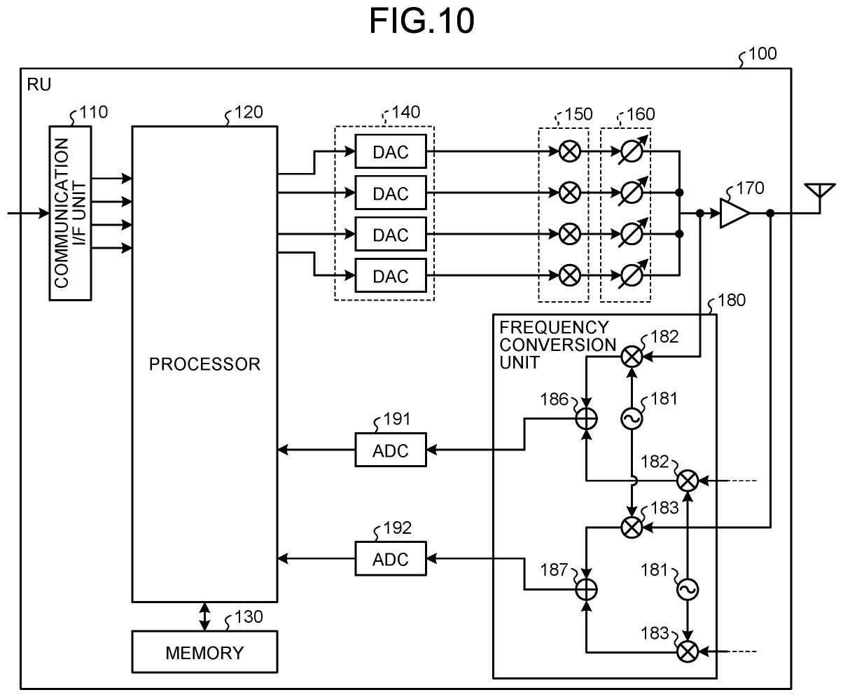

In addition, for example, as illustrated in FIG. 10, the frequency conversion unit 180 includes the plurality of down-converters 182 and 183 that perform down-conversion on the pre-amplified signal and the amplified signal received from the plurality of antenna elements. Then, the pre-amplified signals received from the respective antenna elements may be combined by an adder 186, amplified signals received from the respective antenna elements may be combined by an adder 187, and the combined pre-amplified signal and the combined amplified signal may be fed back to the processor 120. In this case, similarly to the second embodiment, in the processor 120, a difference between the pre-amplified signal and the amplified signal is calculated by digital signal processing.

In each of the embodiments described above, it may be possible to remove the effect of the gain of the power amplifier 170 and the phase rotations in order to obtain the difference between the pre-amplified signal and the amplified signal. Specifically, it may be possible to provide a correction circuit that corrects the gain of the power amplifier 170 and the phase rotations in a feedback path for, for example, the pre-amplified signal. The correction circuit applies the same gain and the same phase rotation as those in the power amplifier 170 to the pre-amplified signal. In addition, it may be possible to provide a correction circuit that applies a gain and a phase rotation that are opposite to those in the power amplifier 170 in a feedback path for, for example, an amplified signal, and it may be possible to correct the amplified signal.

According to an aspect of an embodiment of the wireless communication apparatus and the distortion compensation method disclosed in the present application, an advantage is provided in that it is possible to perform distortion compensation with high accuracy even in the case where beam multiplexing is performed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a processor configured to output a plurality of transmission signals that are transmitted by different beams, respectively;
a plurality of phase shifters configured to be provided in association with antenna elements and apply phase rotations for forming the beams to the plurality of transmission signals, respectively;
a power amplifier configured to amplify a signal that is obtained by combining the transmission signals output from the plurality of respective phase shifters; and
a feedback path configured to feed back a pre-amplified signal that has not been amplified by the power amplifier and an amplified signal that has been amplified by the power amplifier, wherein
the processor executes a process including:
calculating a distortion compensation coefficient based on a difference between the pre-amplified signal and the amplified signal; and
performing distortion compensation on the plurality of transmission signals by using the calculated distortion compensation coefficient.

2. The wireless communication apparatus according to claim 1, wherein the feedback path includes a correction circuit that corrects a gain of the power amplifier and the phase rotations.

3. The wireless communication apparatus according to claim 1, wherein
the feedback path includes
a frequency converter that performs frequency conversion on the pre-amplified signal and the amplified signal by using local signals with inverse phases, and
an adder that adds the pre-amplified signal and the amplified signal that have been subjected to frequency conversion, and
the calculating includes calculating the distortion compensation coefficient based on a difference signal that is output from the adder.

4. The wireless communication apparatus according to claim 1, wherein
the feedback path includes a frequency converter that performs frequency conversion on each of the pre-amplified signal and the amplified signal, and
the calculating includes
calculating a difference between the pre-amplified signal and the amplified signal that are output from the frequency converter, and
calculating the distortion compensation coefficient based on the calculated difference.

5. The wireless communication apparatus according to claim 1, further including a plurality of antenna elements, wherein
the power amplifier is provided in association with each of the plurality of antenna elements, and
the feedback path in which differences between pre-amplified signals and amplified signals associated with the respective power amplifiers are combined and fed back.

6. The wireless communication apparatus according to claim 1, further including a plurality of antenna elements, wherein
the power amplifier is provided in association with each of the plurality of antenna elements, and
the feedback path feeds back a signal that is obtained by combining pre-amplified signals associated with the respective power amplifiers and a signal that is obtained by combining amplified signals associated with the respective power amplifiers.

7. A distortion compensation method performed in a wireless communication apparatus that includes a plurality of phase shifters that are provided in association with antenna elements and apply phase rotations for forming beams to a plurality of transmission signals, respectively, and a power amplifier that amplifies a signal that is obtained by combining the transmission signals that are output from the plurality of respective phase shifters, the distortion compensation method comprising:
providing feedback on a pre-amplified signal that has not been amplified by the power amplifier and an amplified signal that has been amplified by the power amplifier;
calculating a distortion compensation coefficient based on a difference between the pre-amplified signal and the amplified signal; and
performing distortion compensation on the plurality of transmission signals by using the calculated distortion compensation coefficient, using a processor.
